(19) United States
(12) Patent Application Publication
(10) Pub. No.: US 2013/0284780 A1
(43) Pub. Date: Oct. 31, 2013

(54) Multi-Compartment Gun Case for All-Terrain Vehicle

(71) Applicants: Greg Beckwith, Cold Lake (CA); Dennis J. McMillan, Cold Lake (CA)

(72) Inventors: Greg Beckwith, Cold Lake (CA); Dennis J. McMillan, Cold Lake (CA)

(21) Appl. No.: 13/455,462

(22) Filed: Apr. 25, 2012

(51) Int. Cl. B60R 9/06

(52) U.S. Cl. 224/401

(57) ABSTRACT

A multi-compartment gun case for front or rear mount on an ATV is provided. The comprises an upper storage compartment suitable for storage of a rifle and a lower storage compartment suitable for storage of other equipment. The upper storage compartment opens towards the seating position of the ATV to allow for quick and easy access of a stored rifle to the driver without the need to dismount, while the lower storage compartment opens away from the driver towards an area accessible when dismounted so that a user does not need to mount the ATV to access the lower storage compartment.

### FIELD OF THE INVENTION

The invention relates to storage devices for vehicle mount and more specifically to storage devices suitable for storing a gun for mount on an all-terrain vehicle (ATV).

### BACKGROUND

All-terrain vehicles (ATVs) are often used in hunting and riders often mount storage devices to their ATV that include gun storage devices, referred to herein as gun cases, for storing a gun such as a rifle. Gun cases of this type currently available on the market are typically weather-resistant and/or weather-proof, and are made from durable hard or soft material. Most gun cases have a padded, shock-absorbing interior to protect the firearm during transportation. Some gun cases have multi-purpose storage compartments or modules that are attached or integrated to the exterior of the case.

Some examples of typical gun cases include gun boots used for storing a rifle. Generally, gut boots are bracket-mounted on an ATV and block entry onto the ATV on the side on which they are mounted. Gun boots are also cumbersome and space-limiting as they generally do not offer any large storage compartments other than the compartment used for storing the rifle.

Another example of a typical gun case is a generally rectangular gun case, which is horizontally mounted on an ATV. The gun case is mounted at the front of the ATV and opens towards the driver for access to the gun from a riding position in the vehicle. Again however, this type of case can block the riders view when in the open position and in addition does not include a large separate storage area or compartment for storage of additional items.

A need therefore exists for a gun storage device for mount on an ATV which overcomes or at least mitigates at least one of the shortcomings outlined above or observed in the field.

### SUMMARY OF INVENTION

A multi-compartment gun case for mount on an ATV is provided. The multi-compartment gun case is suitable for mount on a front or rear section of the ATV and comprises an upper storage compartment suitable for storage of a rifle and a lower storage compartment suitable for storage of other equipment. The upper storage compartment opens towards the seating position of the ATV to allow for quick and easy access of a stored rifle to the driver without the need to dismount, while the lower storage compartment opens away from the driver towards an area accessible when dismounted so that a user does not need to mount the ATV to access the lower storage compartment. This allows for access to a stored rifle while in a seated position but still allows for egress from the ATV from both sides of the ATV and also easy access to items stored in the lower storage compartment when a user is dismounted and in need of items stored in the multi-compartment gun case.

In one embodiment the invention provides for a multi-compartment gun case for mount on a front or rear section of an all-terrain vehicle (ATV), the multi-compartment gun case comprising:
an upper storage compartment for storing a rifle; and
a lower storage compartment below the upper storage compartment;
wherein the upper storage compartment opens towards a seating position on the ATV; and
wherein the lower storage compartment opens away from the seating position on the ATV.

In a further embodiment of the multi-compartment gun case, the multi-compartment gun case is for mount on the rear section of the ATV and the upper storage compartment is defined by a lower section and a pivotally connected lid.

In a further embodiment of the multi-compartment gun case, the lid is pivotally connected to the lower section at a back side of the lid and the lower section so that the upper storage compartment opens towards the seating position on the ATV.

In a further embodiment of the multi-compartment gun case, the lower section of the upper compartment is pivotally connected to the lower storage compartment on a front side of the lower section and the lower storage compartment so that the lower storage compartment opens away from the seating position on the ATV substantially facing the rear side of the ATV.

In a further embodiment of the multi-compartment gun case, the upper storage compartment comprises a vibration dampening material for receiving a gun.

In a further embodiment of the multi-compartment gun case, either or both of the upper storage compartment and the lower storage compartment is subdivided into a plurality of compartments.

In a further embodiment of the multi-compartment gun case, the case further comprises a tether between the upper compartment and the lower compartment to restrict the pivoting range of motion of the upper compartment relative the lower compartment.

In a further embodiment of the multi-compartment gun case, the case further comprises a tether between the lid and the lower section of the upper compartment to restrict the pivoting range of motion of the lid relative the lower section.

In a further embodiment of the multi-compartment gun case, the tether is a chain, a rope, a string, a hydraulic telescoping arm or a pneumatic telescoping arm.

In a further embodiment of the multi-compartment gun case, the case further comprises a gasket between the lid and the lower section for providing a seal when the lid is in the closed position.

In a further embodiment of the multi-compartment gun case, the case further comprises a gasket between the lower section and the lower storage compartment for providing a seal when the lower storage compartment is in the closed position.

In a further embodiment of the multi-compartment gun case, the lower storage compartment further comprises a drawer opening in a direction away from the seating position on the ATV.

### BRIEF DESCRIPTION OF THE DRAWINGS

FIG. 1 is a front perspective view illustrative of one embodiment of a dual-compartment gun case in closed condition;

FIG. 2 is a back view illustrative of one embodiment of a dual-compartment gun case in closed condition;

FIG. 3 is a plan view illustrative of one embodiment of a dual-compartment gun case in closed condition;

FIG. 4 is a side view illustrative of one embodiment of a dual-compartment gun case, the lower compartment being in open condition; and

FIG. 5 is a side view illustrative of one embodiment of a dual-compartment gun case, the upper compartment being in open condition.

### DETAILED DESCRIPTION

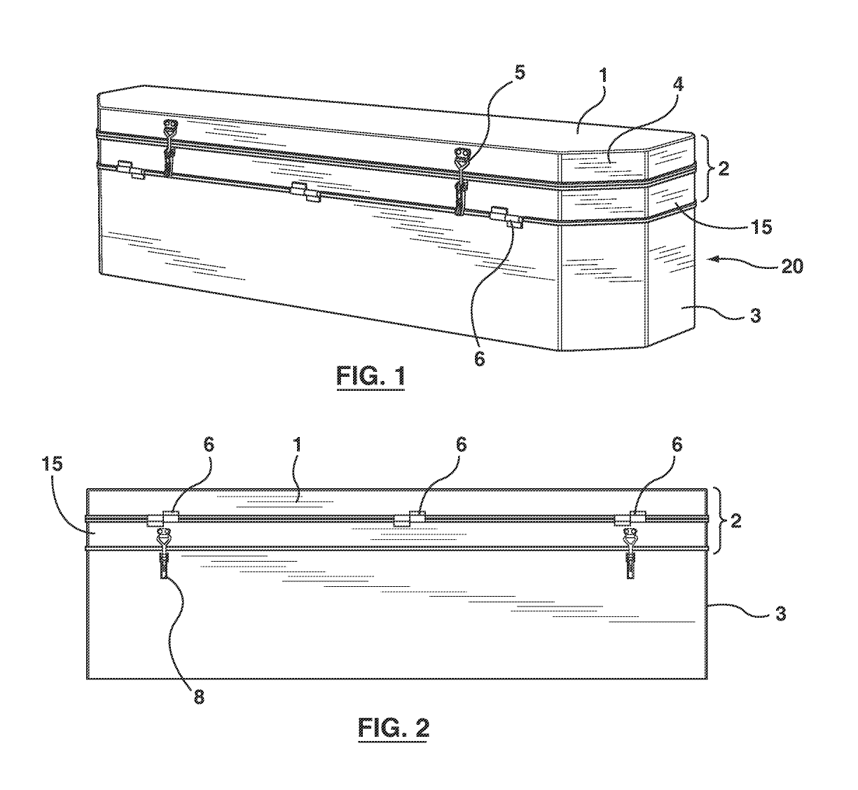

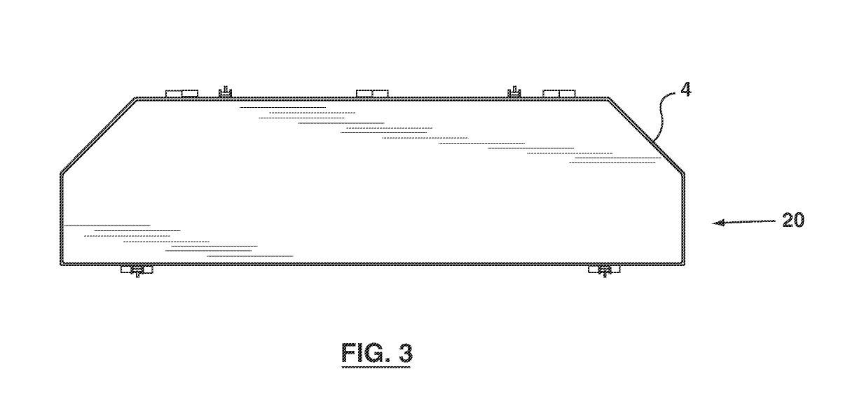

One example of a multi-compartment gun case is shown generally in FIG. 1 at 20. The gun case comprises an upper storage compartment 2 suitable for storing a rifle and a lower storage compartment 3 positioned below the upper storage compartment 2. The upper storage compartment, such as that shown with reference to FIG. 1, is defined by a lower section 15 and a lid 1 that forms the compartment suitable for storing a rifle.

The multi-compartment gun case 20 may be attached to the front or back of an ATV frame using any suitable means including versatile fasteners such as for example u-bolts (not shown) on the bottom of the multi-compartment gun case 20. It will be appreciated that any suitable means of securing the gun case 20 to the ATV may be used and that a u-bolt is merely illustrative and not intended to be limiting.

The case walls are generally formed of rigid material, for example, but not limited to, aluminum checker plate, wood or impact-resistant polymer structural resin. It will be appreciated that any suitable material may be used to form the frame and/or shell of the gun case 20 to provide a rigid operable gun case. The upper compartment 2, which is of size suitable for carrying a rifle, may be lined with a vibration reducing material or malleable material such as foam to receive the gun and minimize damage and wear on the gun during storage and transport and to minimize or prevent the gun from shifting during transportation. In one embodiment the upper compartment is lined with foam in the lower section 15 while in another embodiment both the lower section 15 and the lid 1 are lined with foam.

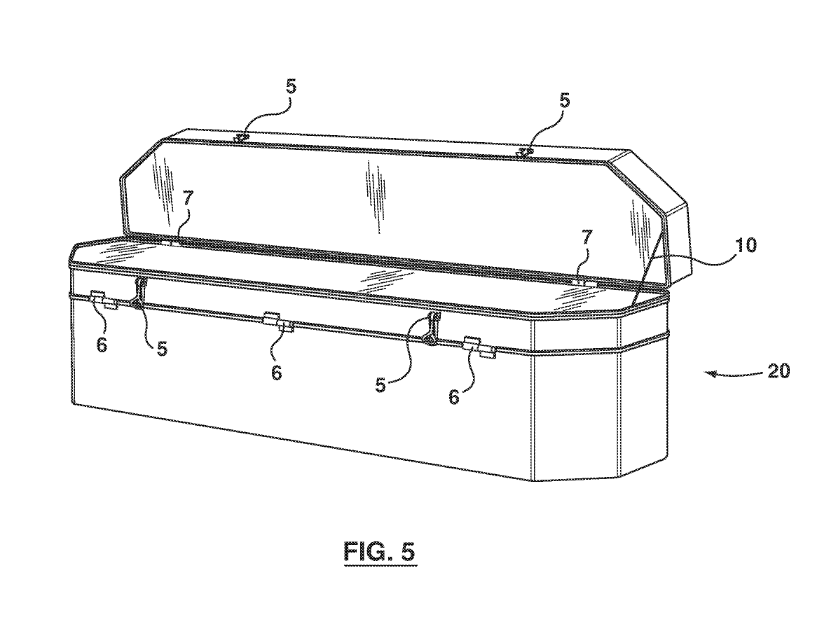

The lid 1 is pivotally connected to the lower section 15 using any suitable means. For example a hinge 7 may be used about which the lid 1 pivots. It will be appreciated that any number and/or type of pivoting connection may be used to join the lid 1 with the lower section 15 for providing a pivotable connection. Although three hinges 7 are illustrated in the Figures, any suitable number or type of hinges are contemplated and may be used. For example, the hinge may be any one or suitable combination of a barrel hinge, pivot hinge, butt/mortise hinge, case hinge, continuous hinge, or piano hinge, concealed hinge, butterfly hinge, flag hinge, strap hinges, or other. To further limit the travel of the lid 1 relative the lower section 15 and to aid in keeping the lid 1 in an opened position, a tether 10, such as a chain, rope, string, or hydraulic or pneumatic telescoping arm on either or both sides of the lid 1 and lower section 15 so as to limit the travel of the lid 1 when in an opened position, as shown for example in FIG. 5.

A gasket 9 may be used to provide an air- and/or watertight seal between the lid 1 and the lower section 15 in order to minimize the ingress of dirt and moisture into the upper storage compartment 2. The upper storage compartment 2 may be secured in a closed position using latches 5, such as for example, draw latches. It will be appreciated that any suitable means of securing or locking the lid 1 in the closed position may be implemented. It will also be appreciated that various jurisdictions require that a firearm be transported in a locked compartment and that the latch 5 may optionally be lockable or include a lock or locking mechanism is order to meet such firearm transport requirements and to provide for safer transport of the firearm stored in the upper storage compartment 2.

The lower storage compartment 3 is positioned below the upper storage compartment 2. The upper storage compartment 2 acts as a lid for the lower storage compartment 3 and is pivotally attached to the lower storage compartment 3. The lower storage compartment 3 opens in a direction suitable for access from an unseated position off of the ATV. In this manner, the upper storage compartment 2 allows for access to its contents by a seated driver, while the lower storage compartment allows for access to contents therein from a user that is dismounted from the ATV. This allows for quick access to a rifle stored in the upper storage compartment 2 by a driver from the seated position while allowing for access to stored products without the need to be seated on the ATV. Generally, the lower storage compartment 3 may open towards any of the sides of the ATV, however, the embodiment shown in Figures shows the upper compartment 2 opening towards the driver while the lower storage compartment opens in an opposite direction towards the rear of the ATV when the gun case 20 is mounted on the rear portion of the ATV.

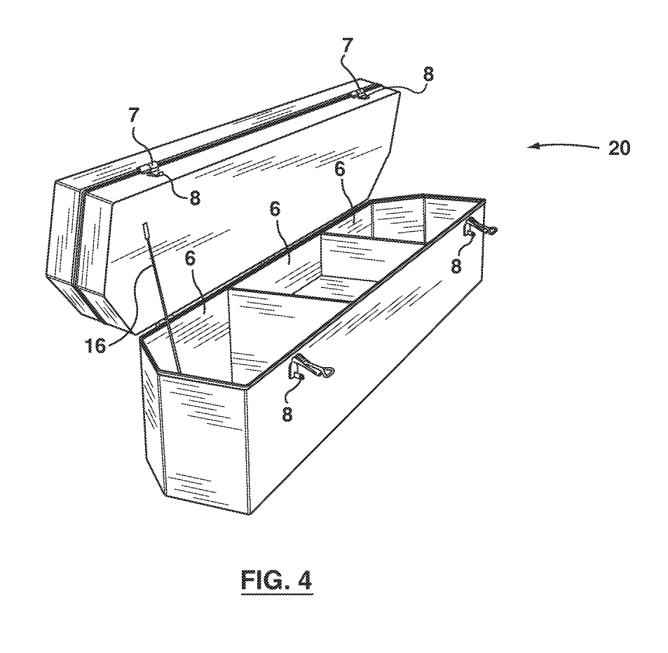

The upper compartment 2 is shown being pivotally connected to the lower storage compartment 3 using a hinged connection 6. The hinges 6 may be located at the opposite sides of the construction from the hinges 7, so that the upper compartment 2 opens in the direction opposite from the opening direction of the lower compartment 3 (as shown in FIGS. 4-5). When connected to either the front section or the back section of an ATV frame, the upper compartment 2 is intended to open towards the driver seated in the vehicle, while the lower compartment 3 is intended to open away from the driver seated in the vehicle, for access by a person standing outside the ATV. It will be appreciated that any number and/or type of pivoting connection may be used to join the upper storage compartment 2 with the lower storage compartment 3 for providing a pivotable connection. For example, the hinge may be one or suitable combination of a barrel hinge, pivot hinge, butt/mortise hinge, case hinge, continuous hinge, or piano hinge, concealed hinge, butterfly hinge, flag hinge, strap hinges, or other.

The range of pivot of the upper storage compartment 2 relative the lower storage compartment 3, may be limited by a tether 16, such as a chain, rope, string, or hydraulic or pneumatic telescoping arm on either or both sides of the compartments so as to prevent the upper storage compartment from opening too far. A gasket (not shown) may be used to provide an air- and/or watertight seal that prevents egress of dirt and moisture into the compartment. The lower storage compartment 3 may be secured or locked shut using any suitable means such as latches 8 including for example a draw latch. It will be appreciated that the latch 8 may be lockable or include a locking mechanism to allow for the secure transport of munitions stored in the lower storage compartment 3. In this way, munitions may be stored in a separate compartment from a firearm stored in the upper storage compartment 2. Storage of munitions in a lockable compartment increases safety and also aids in meeting requirements for transport and/or storage of firearms/munitions in various jurisdictions. In addition, both the upper and lower storage compartments may be lockable so that both the firearm and munitions are stored and/or transported in lockable separate compartments. In addition, to increase safety and further aid in meeting various requirements for transporting firearms/munitions in certain jurisdictions, the latch 5 of the upper storage compartment 2 and latch 8 of the lower storage compartment 3 may be separate keyable locks or separate combination locks thereby requiring separate means for accessing both a firearm stored in the upper storage compartment 2 and munitions stored in the lower storage compartment 3.

Although not shown in the Figures, the upper storage compartment 2 and/or the lower storage compartment 3 may include smaller integrated storage compartments or segregated storage compartments. In addition, the lower storage compartment 3 may include vibration reducing material such as foam in any or all of the compartments or segregated compartments or integrated storage compartments. In addition, a drawer may be incorporated into the lower storage compartment 3 that pulls out in a direction away from the ATV to allow access to the drawer by a person not seated on the ATV.

The generally rectangular design may further include angled front corners 4 to reduce aerodynamic drag, to reduce the risk of brush being snagged on the gun case during travel on narrow paths, or as desired.

The multi-compartment gun case 20 when mounted to the front or rear of an ATV allows for quick access to a rifle stored in the upper storage compartment 2 by a seated driver without the need for dismounting and also allows for egress of the driver from the ATV from each side of the ATV without the path for egress being blocked by the multi-compartment gun case 20. In addition, access to further storage in the lower storage compartment is available to a user dismounted from the ATV which allows for the user to store various items in the lower storage compartment 3 without the need to mount the ATV to access the stored items in the lower storage compartment 3 where it would be onerous to do so. For example, camping equipment may be stored in the lower storage compartment 3 that a user can access from a dismounted position once the ATV has been stopped at a campsite, while a rifle stored in the upper compartment 2 may be accessed from a seated position in the event that a user wants to hunt during travel of the ATV from the seated position.

It will be appreciated that modifications, amendments and improvements other than those outlined herein may be made to the multi-compartment gun case that are within the contemplated multi-compartment gun case without departing from the spirit and/or scope of the contemplated multi-compartment gun case.

We claim:

1. A multi-compartment gun case for mount on a front or rear section of an all-terrain vehicle (ATV), the multi-compartment gun case comprising:
an upper storage compartment for storing a rifle; and
a lower storage compartment below the upper storage compartment;
wherein the upper storage compartment opens towards a seating position on the ATV; and
wherein the lower storage compartment opens away from the seating position on the ATV.

2. The multi-compartment gun case according to claim 1, wherein the multi-compartment gun case is for mount on the rear section of the ATV and the upper storage compartment is defined by a lower section and a pivotally connected lid.

3. The multi-compartment gun case according to claim 2, wherein the lid is pivotally connected to the lower section at a back side of the lid and the lower section so that the upper storage compartment opens towards the seating position on the ATV.

4. The multi-compartment gun case according to claim 2, wherein the lower section of the upper compartment is pivotally connected to the lower storage compartment on a front side of the lower section and the lower storage compartment so that the lower storage compartment opens away from the seating position on the ATV substantially facing the rear side of the ATV.

5. The multi-compartment gun case according to claim 3, wherein the lower section of the upper compartment is pivotally connected to the lower storage compartment on a front side of the lower section and the lower storage compartment so that the lower storage compartment opens away from the seating position on the ATV substantially facing the rear side of the ATV.

6. The multi-compartment gun case according to claim 1, wherein the upper storage compartment comprises a vibration dampening material for receiving a gun.

7. The multi-compartment gun case according to claim 1, wherein either or both of the upper storage compartment and the lower storage compartment is subdivided into a plurality of compartments.

8. The multi-compartment gun case according to claim 1, further comprising a tether between the upper compartment and the lower compartment to restrict the pivoting range of motion of the upper compartment relative the lower compartment.

9. The multi-compartment gun case according to claim 2, further comprising a tether between the lid and the lower section of the upper compartment to restrict the pivoting range of motion of the lid relative the lower section.

10. The multi-compartment gun case according to claim 8, wherein the tether is a chain, a rope, a string, a hydraulic telescoping arm or a pneumatic telescoping arm.

11. The multi-compartment gun case according to claim 9, wherein the tether is a chain, a rope, a string, a hydraulic telescoping arm or a pneumatic telescoping arm.

12. The multi-compartment gun case according to claim 2 further comprising a gasket between the lid and the lower section for providing a seal when the lid is in the closed position.

13. The multi-compartment gun case according to claim 1 further comprising a gasket between the lower section and the lower storage compartment for providing a seal when the lower storage compartment is in the closed position.

14. The multi-compartment gun case according to claim 1, wherein the lower storage compartment further comprises a drawer opening in a direction away from the seating position on the ATV.

15. The multi-compartment gun case according to claim 1, wherein the upper storage compartment is a lockable compartment and the lower storage compartment is a lockable compartment and wherein the upper storage compartment requires a different key or combination to unlock than the lower storage compartment.
